(19) United States
(12) Patent Application Publication
(10) Pub. No.: US 2008/0250685 A1
(43) Pub. Date: Oct. 16, 2008

(54) Illuminated Sign with Single-Point LED Light Source

(75) Inventors: Ron C.J. Bijman, Delfgauw (NL); Camille Descarries, Montreal (CA); Patrick Martineau, Ile-Perrot (CA)

Correspondence Address: HOFFMANN & BARON, LLP, 6900 JERICHO TURNPIKE, SYOSSET, NY, 11791, US

(73) Assignee: THOMAS & BETTS INTERNATIONAL, INC., Wilmington, DE (US)

(21) Appl. No.: 12/037,152

(22) Filed: Feb. 26, 2008

Related U.S. Application Data
(60) Provisional application No. 60/922,747, filed on Apr. 10, 2007.

(51) Int. Cl. G09F 13/04

(52) U.S. Cl. 40/570; 40/564

(57) ABSTRACT

An illuminated sign includes a light source with a light emitting diode, and a sign panel. The sign panel is at least partially transparent, and the light source is at least partially embedded in the sign panel, thereby illuminating the sign panel. The sign may be mounted to a wall, ceiling, or any other mounting surface, and used as an emergency exit sign. The sign may be single- or double-sided with two panels separated by reflective material. The sign may include a positionable joint coupled to the sign panel, which selectively orients the sign panel with respect to a mounting surface, and a high-intensity light emitting diode adapted to provide floodlighting. A method of illuminating a sign includes providing a light source including a light emitting diode, and embedding the light source at least partially in a sign panel. The sign panel is at least partially transparent, thereby illuminating the sign panel.

### CROSS-REFERENCE TO RELATED APPLICATION

This application claims the benefit of U.S. Provisional Patent Application No. 60/922,747 filed Apr. 10, 2007, the disclosure of which is incorporated herein by reference.

### BACKGROUND OF THE INVENTION

1. Field of the Invention

The present invention generally relates to lighting fixtures. In particular, the present invention provides for a sign to be illuminated with an embedded single-point LED light source.

2. Description of the Related Art

Emergency exit signs that include transparent acrylic panels are commercially available. These signs are typically illuminated by a series of light emitting diodes (LEDs) mounted along the edge of a transparent panel. For an even light intensity and distribution, many LEDs are required and must be equally spaced along the edge of the panel. The light sources are not embedded in the panel and are barely in contact with its edge.

One of the disadvantages of such signs is that the light sources must be spread out and, as a result, the efficiency of light transmission to the acrylic medium is far from ideal. Thus, additional light sources must be provided to compensate for losses due to poor transmission or transfer to the transparent panel.

### SUMMARY OF THE INVENTION

An illuminated sign formed in accordance with one form of the present invention, which incorporates some of the preferred features, includes a light source including a light emitting diode, and a sign panel. The sign panel is at least partially transparent, and the light source is at least partially embedded in the sign panel, thereby illuminating the sign panel.

The sign panel may include text, a symbol, a pictogram, and/or graphics engraved or embedded thereon or therein. The illuminated sign may be mounted to a wall, ceiling, or any other mounting surface. The illuminated sign may be used as an emergency exit sign, and may be double-sided with two panels separated by reflective material. The sign may include a holding fixture, the light source may be at least partially disposed within the holding fixture, and the holding fixture may mount the sign panel to a mounting surface. The holding fixture may position the sign panel parallel, normal, or at any other angle with respect to the mounting surface. The illuminated sign may include a positionable joint coupled to the sign panel, which selectively orients the sign panel with respect to a mounting surface, and a high-intensity light emitting diode adapted to provide floodlighting.

A method of illuminating a sign formed in accordance with one form of the present invention, which incorporates some of the preferred features, includes providing a light source including a light emitting diode, and embedding the light source at least partially in a sign panel, wherein the sign panel is at least partially transparent, thereby illuminating the sign panel.

The method may include engraving or embedding text, a symbol, a pictogram, and/or graphics on or in the sign panel. The method may include mounting the sign panel to a wall, a ceiling, or any other mounting surface. The method may include providing the sign panel as two panels separated by reflective material, disposing the light source at least partially within a holding fixture that mounts the sign panel to a mounting surface, and positioning the sign panel parallel, normal, or at any other angle relative to the mounting surface. The method may include coupling a positionable joint, which is adapted to selectively orient the sign panel with respect to a mounting surface, to the sign panel, and providing a high-intensity light emitting diode adapted to provide floodlighting.

These and other objects, features, and advantages of this invention will become apparent from the following detailed description of illustrative embodiments thereof, which is to be read in connection with the accompanying drawings.

### BRIEF DESCRIPTION OF THE DRAWINGS

FIGS. 1a-c show front and side views of an embodiment of the illuminated sign in accordance with the present invention installed on a ceiling.

FIG. 2 shows another embodiment of the illuminated sign installed on a wall.

FIGS. 3a-b show front and side views of another embodiment of the illuminated sign installed on a wall.

FIGS. 4a-c show front and side views of another embodiment of the illuminated sign installed on a ceiling.

FIGS. 5a-b show another embodiment of the illuminated sign installed on a wall.

FIG. 6 shows another embodiment of the illuminated sign installed on a wall.

FIG. 7 shows another embodiment of the illuminated sign installed on a wall.

FIGS. 8a-c show another embodiment of the illuminated sign including a pivotal installation.

FIGS. 9a-c show another embodiment of the illuminated sign installed on a wall.

FIG. 10 shows another embodiment of the illuminated sign installed on a wall.

FIG. 11 shows another embodiment of the illuminated sign with a dual light source.

FIG. 12 shows another embodiment of the illuminated sign with floodlighting.

FIGS. 13a-c show various embodiments of a panel used in the illuminated sign.

FIGS. 14a-d show a light path through various embodiments of the panel used in the illuminated sign.

FIGS. 15a-b show light paths through various embodiments of the panel used in the illuminated sign.

FIGS. 16a-c show light paths through various embodiments of the panel used in the illuminated sign.

FIGS. 17a-c show light paths through various embodiments of the panel used in the illuminated sign.

FIG. 18 shows light paths through a double-sided panel used in the illuminated sign.

FIGS. 19, 20a, 20b, 21a, 21b, and 22a-c show simulated light paths for various embodiments of the panel.

FIGS. 23a and 23b show alternative embodiments of the panel.

FIGS. 24a and 24b show a holding fixture used in the illuminated sign.

FIG. 25 shows a detailed view of the panel used in the illuminated sign.

FIG. 26 shows a perspective view of the holding fixture shown in FIGS. 24a and 24b used in the illuminated sign.

### DETAILED DESCRIPTION OF THE PREFERRED EMBODIMENTS

The present invention is directed to an illuminated sign 10, which includes a high-power, high-intensity light emitting diode (LED) embedded in a transparent panel, such as an acrylic panel, which efficiently disperses light uniformly through the sign from the LED. It is envisioned that one LED is sufficient for most applications, but that more LEDs could be used while remaining within the scope of the present invention. The transparent panel preferably includes the word “EXIT” or other words, symbols, and/or pictograms embedded, printed, and/or engraved therein or thereon. Using a single-point light source, the illuminated sign can be aesthetic, with the transparent panel suspended by a simple yet elegant holding fixture.

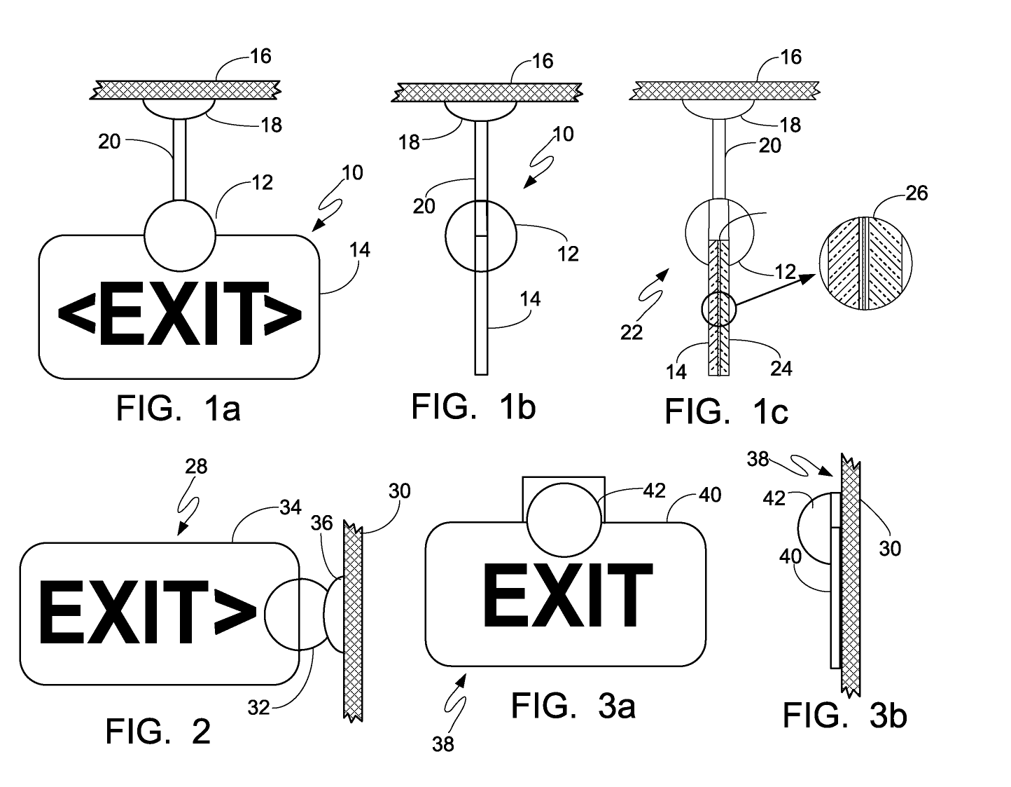

FIG. 1a shows a preferred embodiment of the illuminated sign 10 formed in accordance with the present invention. A single-point light source (not shown) is preferably embedded in a round-shaped holding fixture 12. A single-sided clear panel 14 having text, symbols, pictograms, and/or the like embossed and/or engraved on, or in, it is attached to a ceiling 16 with a pendant kit, which includes a canopy 18 and a tube 20 connecting the holding fixture 12 to the canopy 18. The length of the tube 20 is preferably variable. FIG. 1b shows a side view of the illuminated sign 10 shown in FIG. 1a. FIG. 1c shows a side view of another embodiment of the illuminated sign 22, which includes two clear panels 14, 24 (double-sided), each of which is preferably illuminated by the same single-point light source (not shown) within the holding fixture 12, and separated by a reflective sheet 26, such as a Mylar® sheet.

FIG. 2 shows another embodiment of the illuminated sign 28 formed in accordance with the present invention intended for side mounting to a wall 30, wherein the flat panel 34 is preferably normal to the wall 30. A single-point light source (not shown) is preferably embedded in a round-shaped holding fixture 32. The single-sided clear panel 34 is preferably attached to the wall 30 with a canopy 36 integrated with the holding fixture 32.

FIGS. 3a and 3b show front and side views, respectively, of another embodiment of the illuminated sign 38 formed in accordance with the present invention intended for essentially flat mounting to the wall 30. In this embodiment, the panel 40 is substantial parallel with the wall 30. This method of mounting allows the sign 38 to be brought closer to the wall 30, such that it can be made as unobtrusive as possible. A single-point light source (not shown) is preferably embedded in the holding fixture 42. A single-sided panel 34 having text, symbols, pictograms, and/or the like embossed and/or engraved on or in, it is preferably attached to the wall 30 by the holding fixture 42.

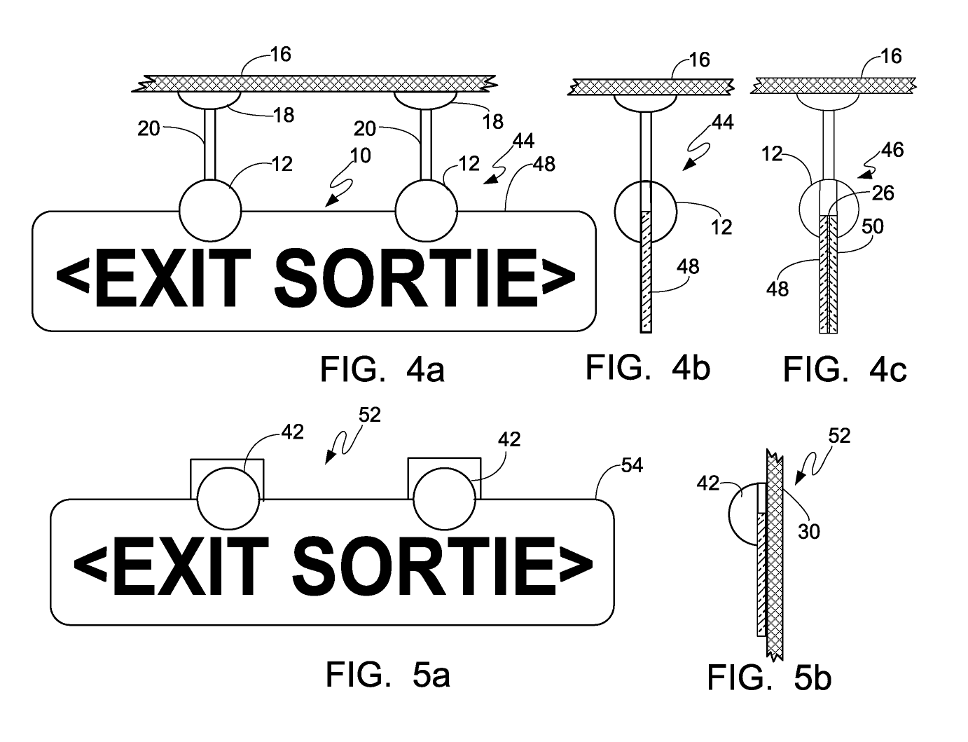

FIGS. 4a-c show additional embodiments of the illuminated sign 44, 46 formed in accordance with the present invention, in which the panels 48, 50 need to be longer than that shown in FIGS. 1a-c, such as with bilingual signs. In this case, more than one holding fixture 12 is preferably used to embed a single-point light source (not shown) and attach the panels 48, 50 to the ceiling. The panels 48, 50 are attached to the ceiling 16 with a pendant kit, which includes the canopies 18 and tubes 20 connecting the holding fixtures 12 to the canopies 18. The length of the tubes 20 is preferably variable. FIG. 4b shows a side view of the illuminated sign 48 shown in FIG. 4a. FIG. 4c shows a side view of another embodiment of the illuminated sign 46, which includes two clear panels 48, 50 (double-sided), each of which is preferably illuminated by the same single-point light sources (not shown), held up by holding fixtures 12, and separated by a reflective sheet 26.

FIGS. 5a-b show front and side views of another embodiment of the illuminated sign 52 formed in accordance with the present invention intended for mounting to the wall 30, wherein the panel 54 is substantially parallel with the wall 30. This method of mounting allows the sign 52 to be brought close to the wall 30, such that it can be made as unobtrusive as possible. Single-point light sources (not shown) are preferably embedded in holding fixtures 42. The single-sided panel 54 is preferably attached to the wall 30 using holding fixtures 42.

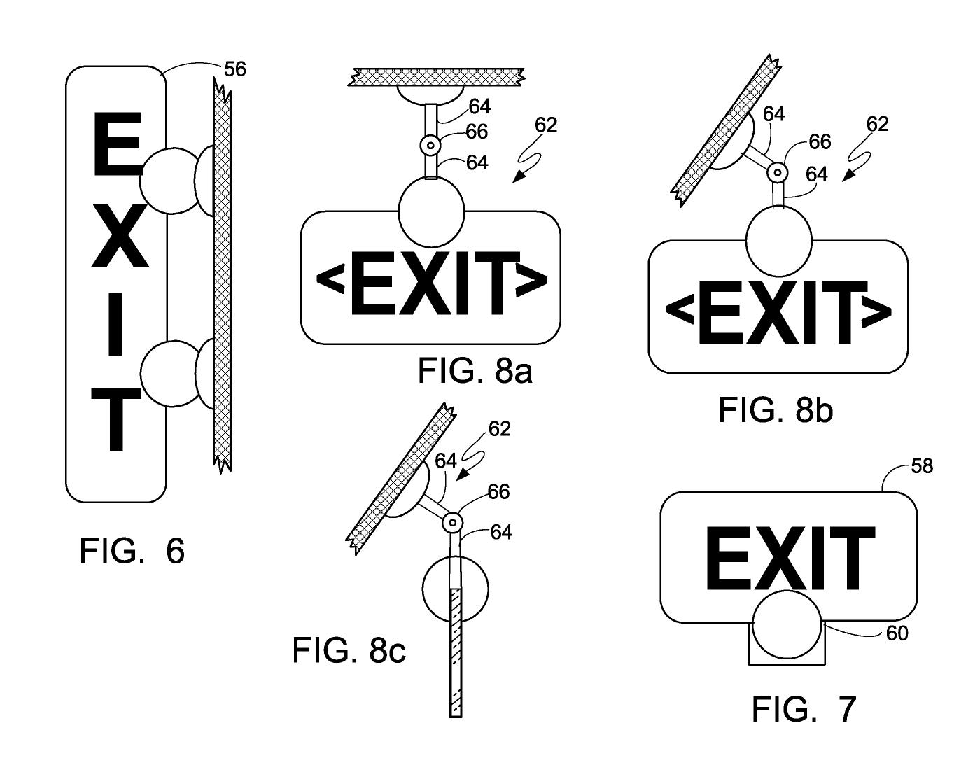

FIG. 6 shows a front view of another embodiment similar to that shown in FIG. 2, except that the panel 56 and lettering are arranged vertically. FIG. 7 shows a front view of another embodiment similar to that shown in FIG. 3, except that the panel 58 is lit and supported from the holding fixture 60 mounted below the panel 58. FIGS. 8a-c show front and side views of another embodiment of the illuminated sign 62 that is similar to that shown in FIGS. 1a-b, except that it includes a swiveling or adjustable joint 66 that permits the sign 62 to be mounted to ceilings, walls, or any surface regardless of its angle with respect to the intended orientation of the sign 62.

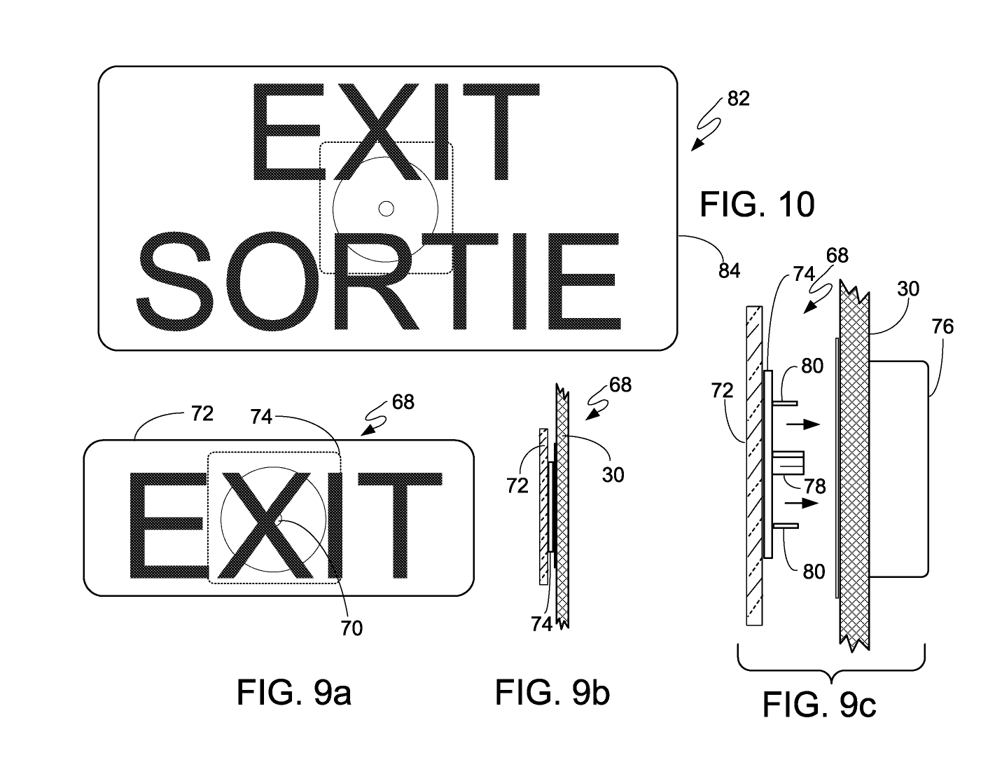

FIG. 9a-c show front and side views of another embodiment of the illuminated sign 68 formed in accordance with the present invention, in which the single-point light source 70 is preferably embedded in the center of the panel 72. The sign 68 is preferably mounted to the wall with a plate 74 attached to a rear surface of the panel 72. This embodiment 68 preferably protrudes only a small distance from the wall 30 making for an essentially flush mounting. FIG. 9c shows a preferred method for connecting the light source in the sign 68 to an electrical box 76 mounted in the wall using an electrical connector 78 and aligning pins 80, which enable changing or replacing the sign 68 without tools. FIG. 10 shows another embodiment of the sign 82 that is similar to that shown in FIGS. 9a-c, except that the panel 84 is larger, such as for use in bilingual signs.

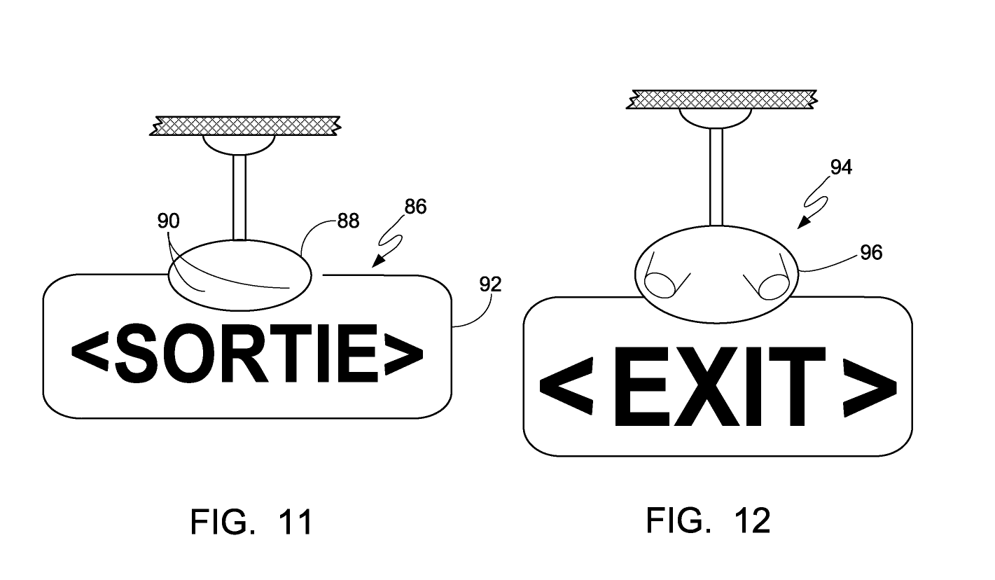

FIG. 11 shows another embodiment of the sign 86 that is similar to that shown in FIG. 1a, except that the holding fixture 88 is oval-shaped rather than circular and may have two light sources 90 for illumination of a larger panel 92. FIG. 12 shows another embodiment of the sign 94 that is similar to that shown in FIG. 11, except that the holding fixture 96 preferably includes high-intensity white LEDs for floodlighting in emergency situations. The same concept may be used for double-sided signs, such as that shown in FIG. 1c, by increasing the number of high-intensity white LEDs, such as by providing two such LEDs on each side of the sign.

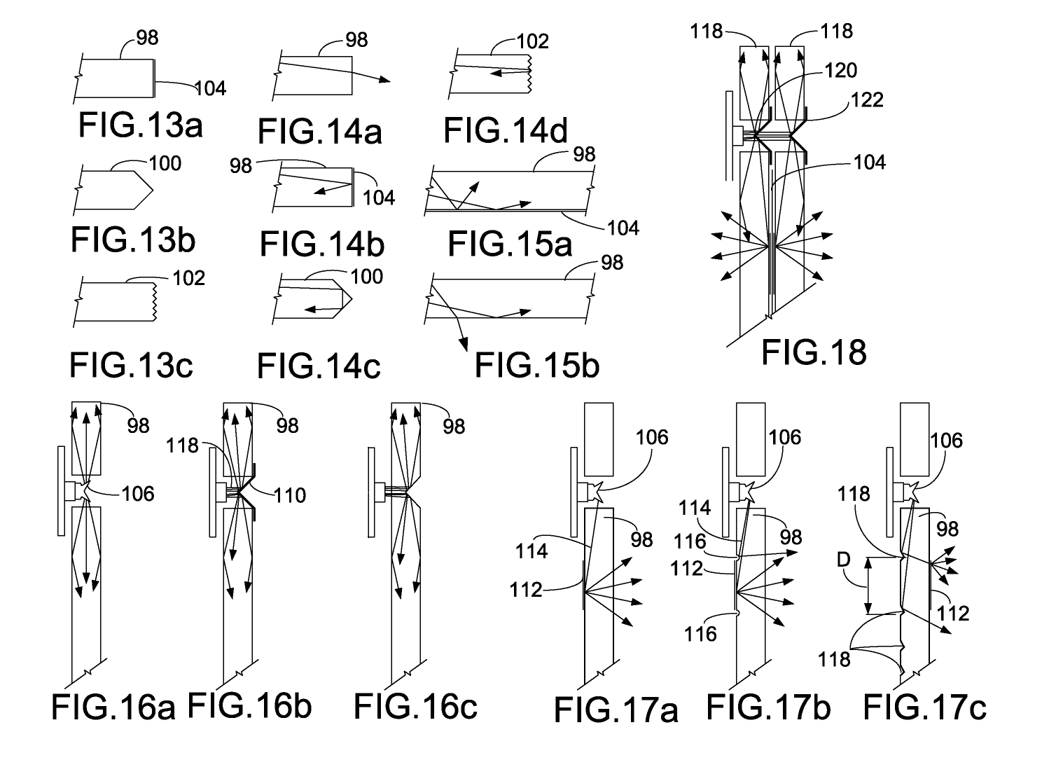

FIGS. 13a-c show various embodiments of the panel 98, 100, 102 adapted to confine light emitted by an LED inside the panel. This can be achieved by placing reflective material 104 along an edge of the panel 98 shown in FIG. 13a, or by shaping the edges of the panel 100 such that Total Internal Reflection (TIR) occurs as shown in FIG. 13b. The edge of the panel 102 can also be made such that each linear portion of the edge is shorter, as shown in FIG. 13c, which substantially improves manufacturability. For this embodiment, reflection also occurs with TIR.

FIGS. 14a-d show the loss and retention of light by various edge configurations of the panels 98, 100, 102. FIG. 14a shows the loss of light as it passes unreflected from the edge of the panel 98. FIG. 14b shows the retention of light by reflective tape 104 along the edge of the panel, FIG. 14c shows retention of light by TIR, and FIG. 14d show retention by reflection from shortened linear portions of the edge.

FIG. 15a shows that efficiency can be improved by placing reflective tape 104 on the back of the panel 98. However, it may be more cost effective to use TIR without reflective material on the back surface of the panel 98, as shown in FIG. 15b.

FIGS. 16a-c show various embodiments of the invention used to redirect light from the LED to the panel 98. In FIG. 16a, an LED 106 with a lateral distribution is used. In FIG. 16b, an LED 108 having a Lambertian or wide viewing angle is used with a reflective cone 110 located in front of the LED 108. The embodiment in FIG. 16c is similar to that shown in FIG. 16b, except that TIR is used to redirect the light from the LED 108.

FIGS. 17a-c show three embodiments of how to generate a clear pictogram from the illuminated sign in accordance with the present invention. FIGS. 17a-b show the preferred approach, in which a colored diffused material 112 is placed on the rear surface of the panel 98. Light rays 114 that hit this material 112 are scattered, thus making the pictogram visible. An outline 116 of the pictogram may be engraved in the panel 98 to provide a brighter contour on the pictogram, as shown in FIG. 17b. It is also possible to generate a pattern 118 on the rear surface of the panel 98 to redirect the light forward, as shown in FIG. 17c. The distance D between elements of the pattern 118 may vary in order to improve the uniformity of the light. For example, the distance D can be made greater at positions nearer the LED 106. However, in the embodiment shown in FIG. 17c, the colored diffused material 112 is preferably placed on the front of the panel 98.

FIG. 18 shows a double-sided panel 118, in which the pictogram is visible from both sides of the panel 118. This embodiment is similar to that shown in FIG. 16b, except that in this embodiment there are two cones 120, 122. The first cone 120 preferably permits about 50% of the light to pass, while the second cone 122 preferably blocks 100% of the light. In this way, 50% of the light is preferably visible from either side of the sign. Reflective material 104 is preferably applied between the panels 118.

In accordance with the present invention, it is to be noted that reflective material is preferably provided on outer edges of illuminated signs having straight edges, such as square, rectangular, and/or triangular signs, but is preferably not provided on outer edges of signs having other shapes.

It is anticipated that the following modifications could be made to the embodiments described herein while remaining within the scope of the present invention:

double panel, double-sided, multi-panel, and/or multi-sided signs;

signs having various colors;

signs having different mounting planes, such as ceiling, wall, and end mounted signs;

multiple light sources, for use in larger signs, such as bilingual signs, or signs including pictograms of any size;

various power sources for the LED(s) including, but not limited to AC, DC, AC-DC, AC with battery backup, and the like; and

various mounting locations for the LED driving electronics, such as in the canopy, in the holding fixture, and/or remote from the sign.

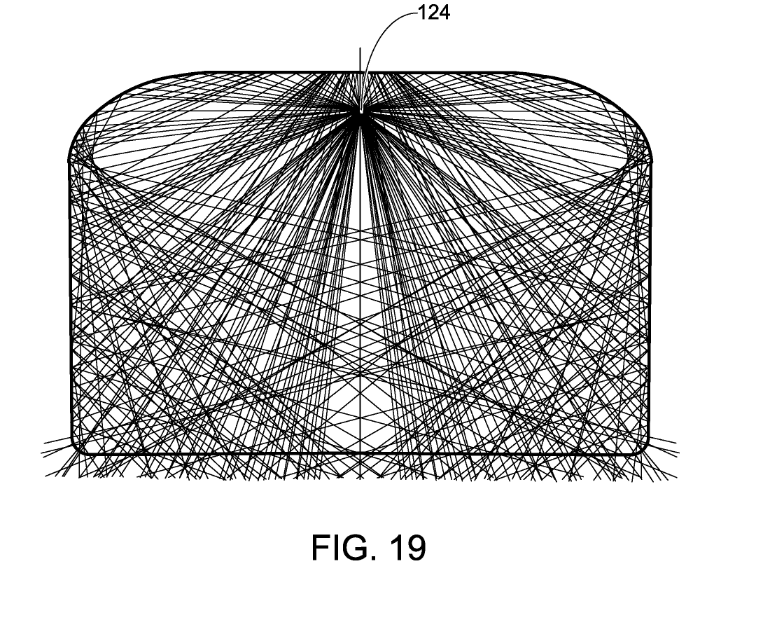

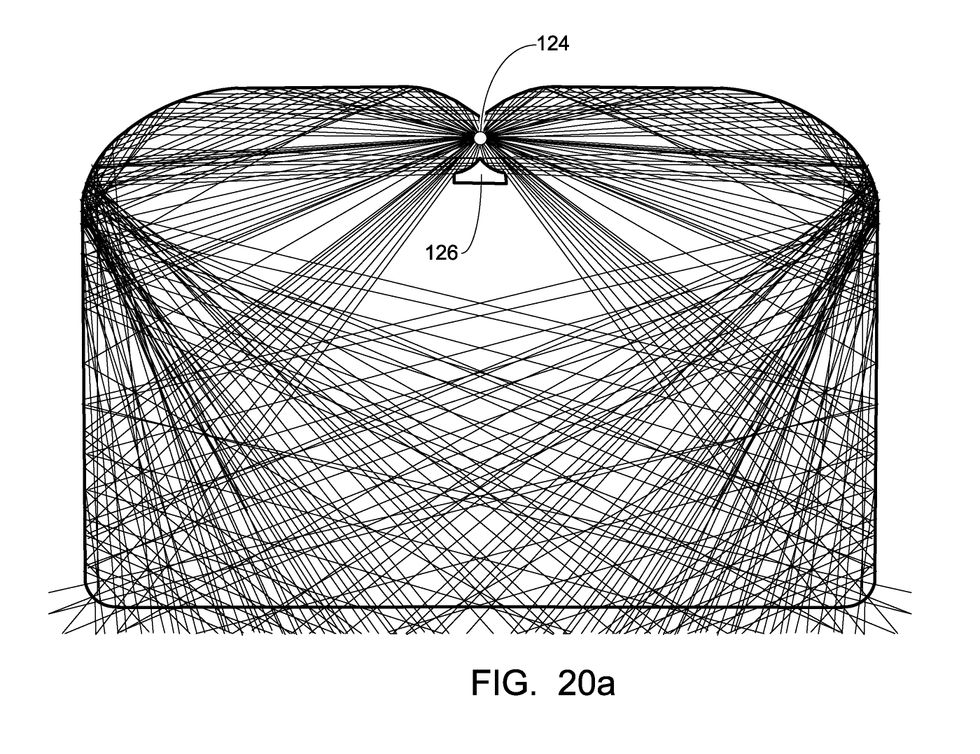

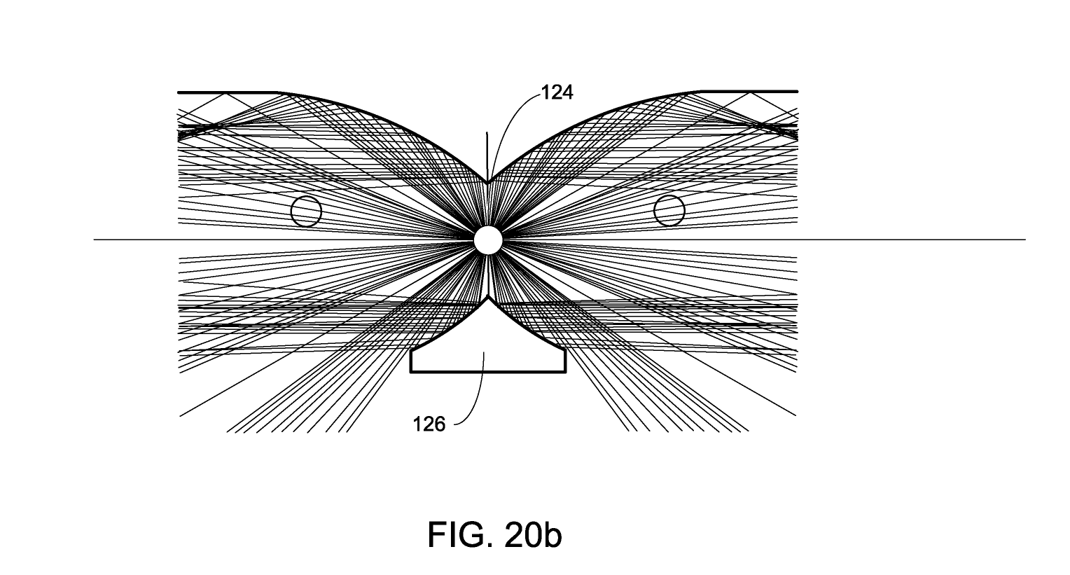

FIGS. 19, 20a, 20b, 21a, 21b, and 22a-c show simulated light paths for various embodiments of the panel. FIG. 19 shows that corner geometry improves Total Internal Reflection (TIR), and a higher concentration of light around the single-point light source 124 due to reflected and direct light rays, which accounts for non-uniformity of the legend under these conditions. FIG. 20a shows that light concentration can be controlled by adding a geometrical form 126 around the source 124. The rays thus redirected may be used to improve light uniformity on the entire surface of the legend. Without the geometrical form 26, the legend appears too bright near the LED. FIG. 20b shows a more detailed view of the geometrical form 126. With a highly polished edge and appropriate geometry, it is possible to reflect all of the light without using reflective material at the edges of the panel. Thus, TIR may be sufficient.

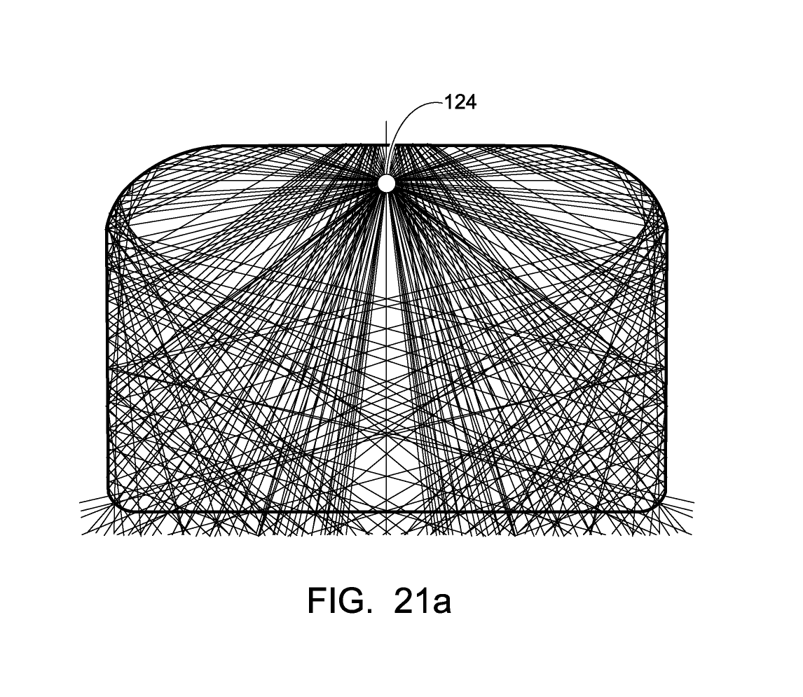

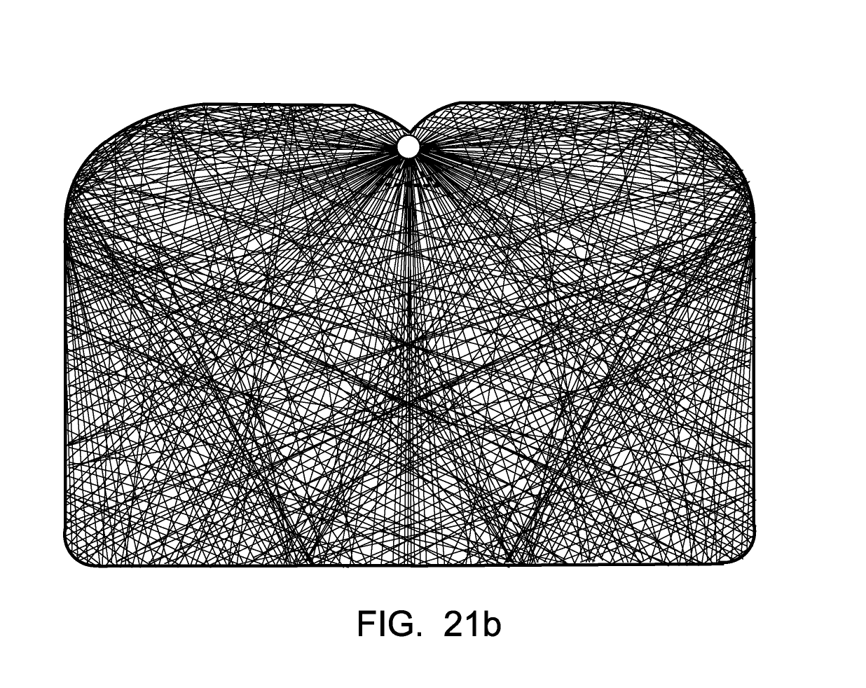

FIG. 21 a shows the light concentration under the single-point light source 124, if the geometrical form 126 is not used.

FIG. 21b shows improved uniformity of the light rays with an eighty (80) percent (%) threshold.

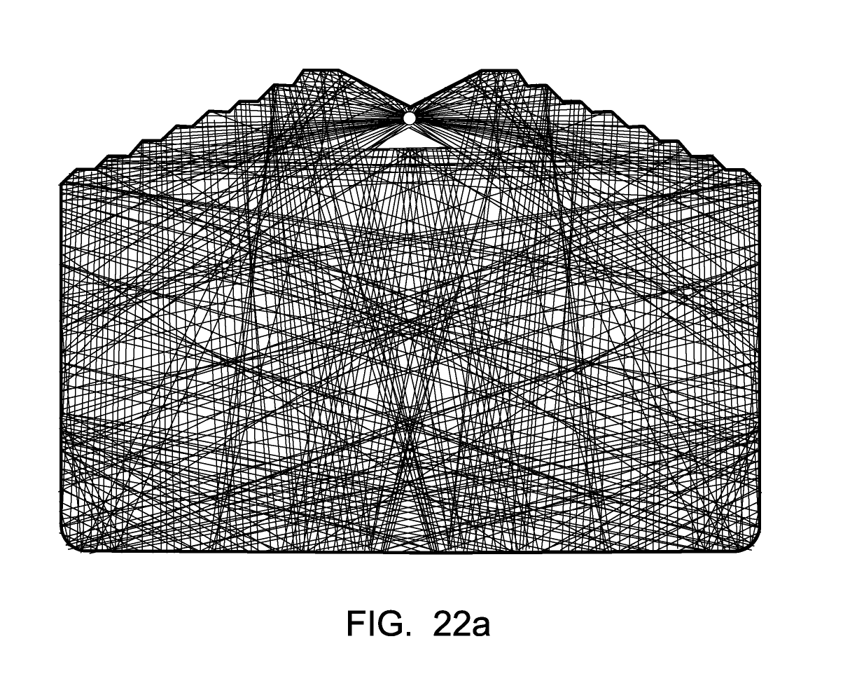

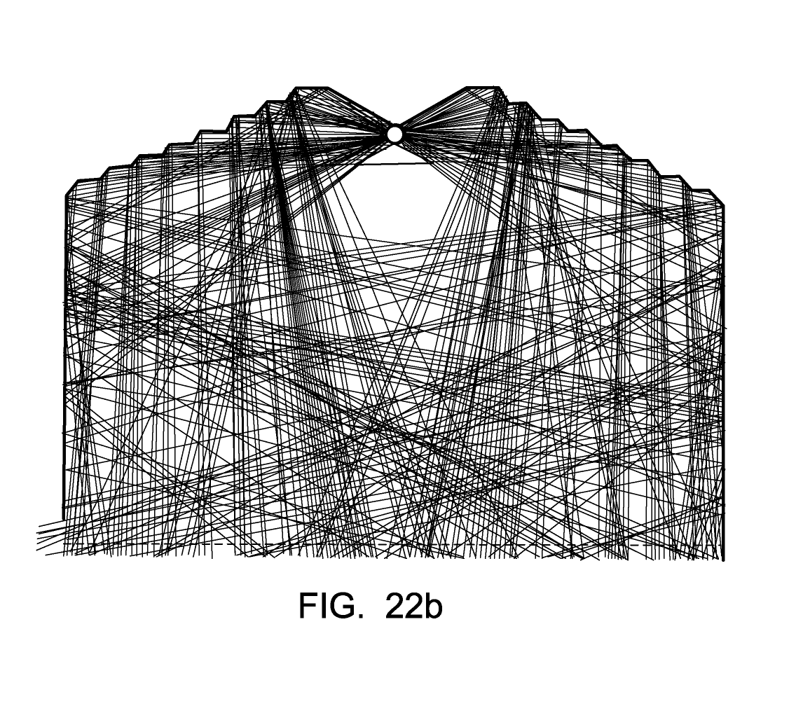

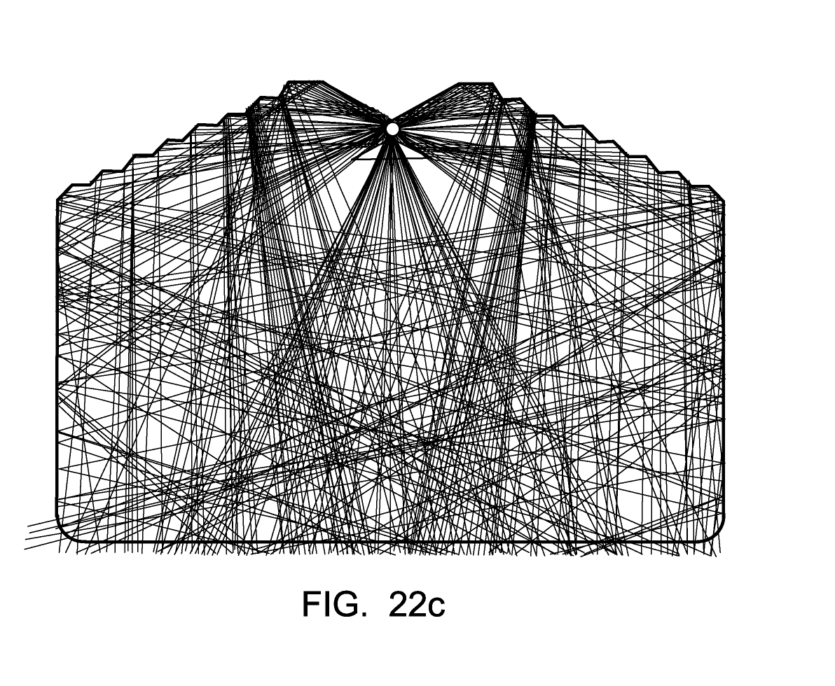

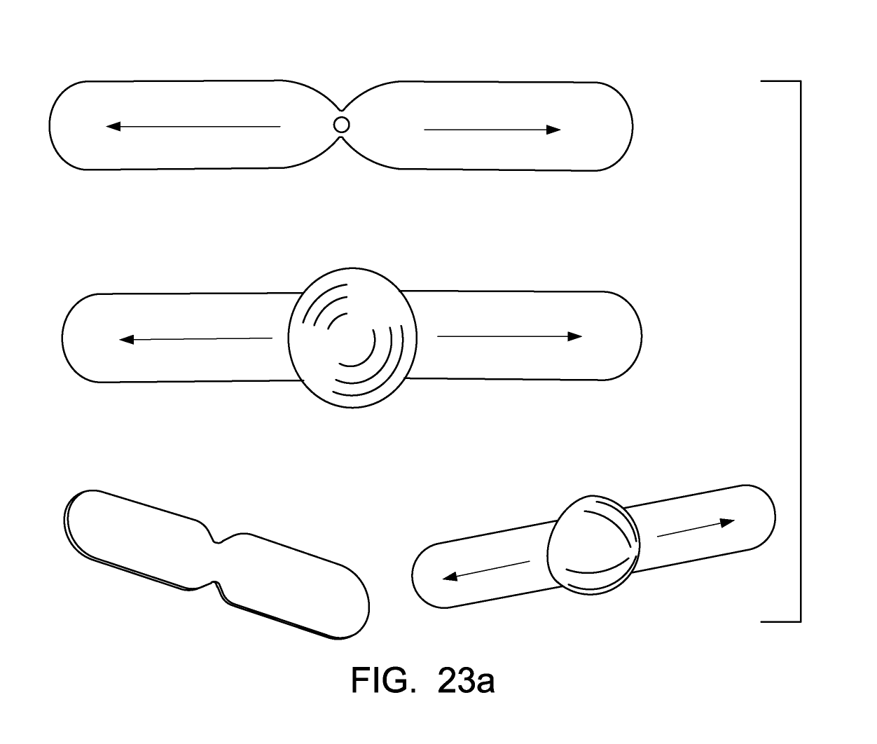

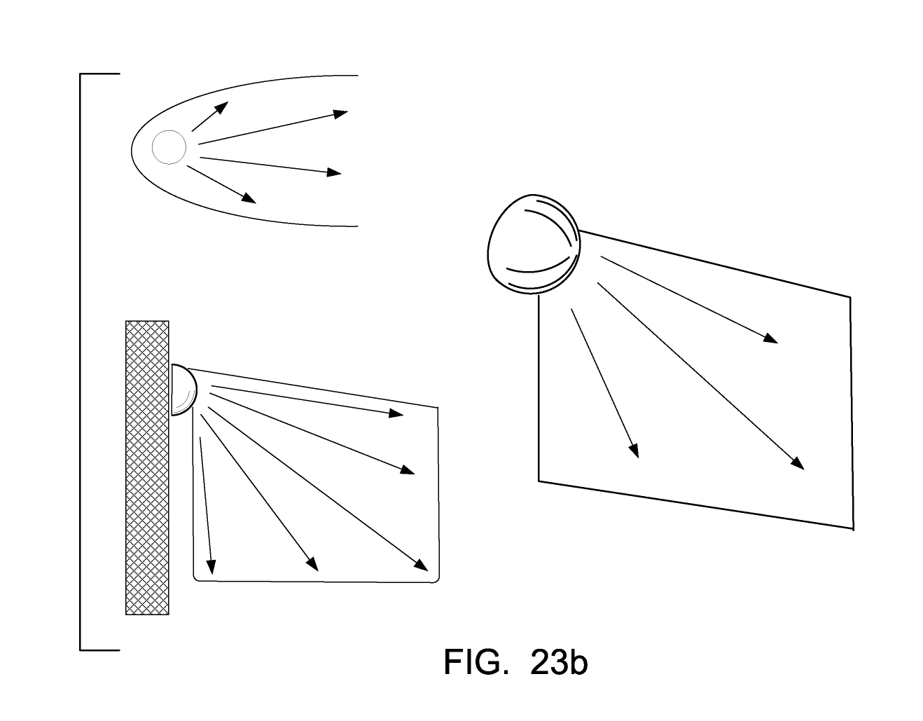

FIG. 22a shows improved uniformity through horizontal orientation of the light rays followed by vertical orientation. FIG. 22b shows a reduction in uniformity due to the lack of reflective material on the bottom edge of the panel, and FIG. 22c shows an improvement in uniformity if the geometrical form 126 (shown in FIG. 20a around the source 124) is removed.

FIGS. 23a-d show an embodiment having a very thin legend, in which light is predominantly directed towards both sides of the sign. FIGS. 23b-f show that a hyperbolic surface can redirect light towards the side of the panel.

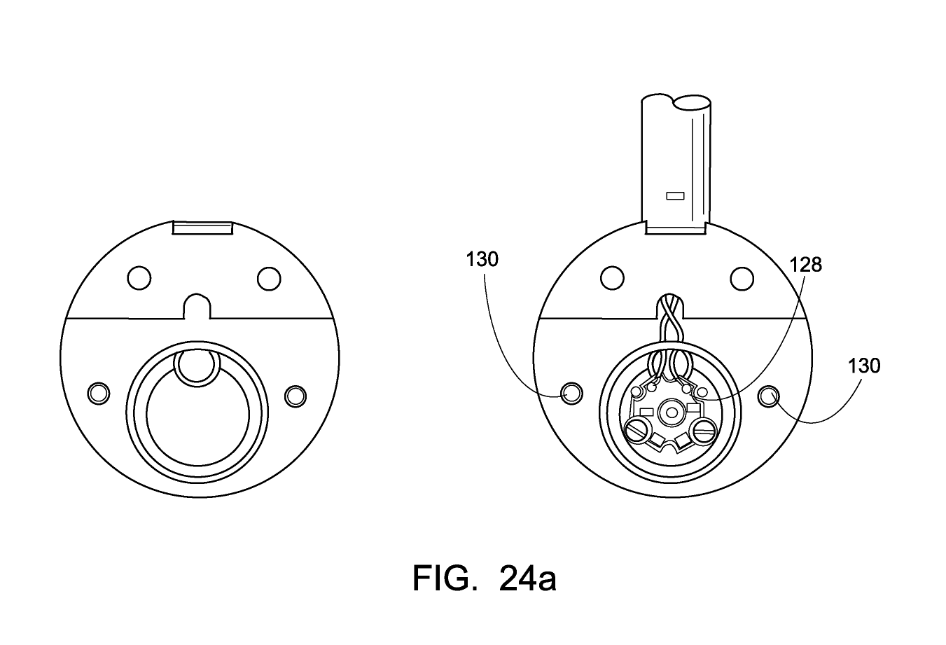

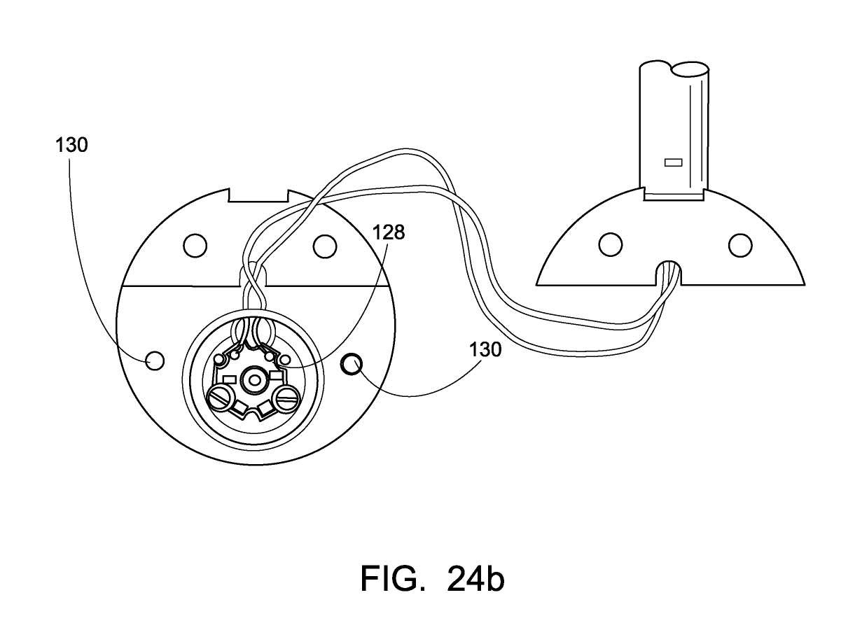

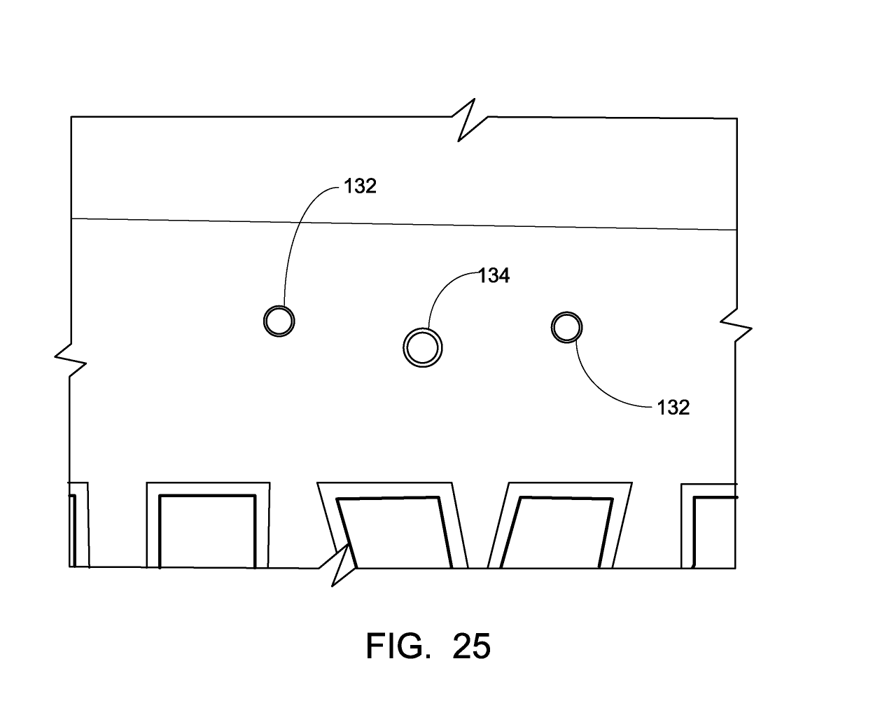

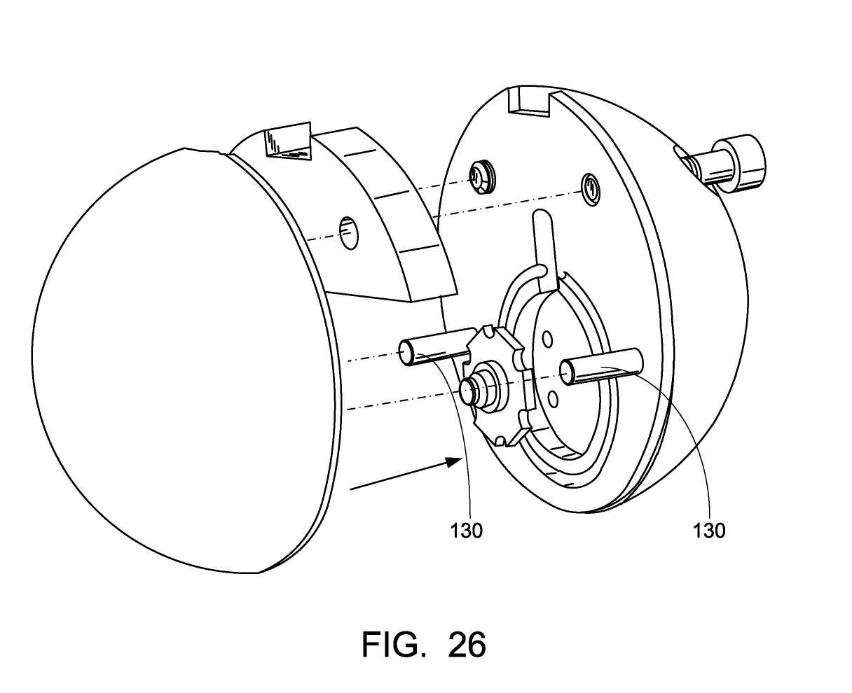

FIGS. 24a-b show internal views of holding fixture assemblies for use in the illuminated sign including the LED 128 and alignment pins 130. FIG. 25 shows a view of alignment holes 132 and an LED well 134 in the panel of the illuminated sign. FIG. 26 shows a perspective view of the holding fixture shown in FIGS. 24a-b.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. An illuminated sign comprising:
a light source comprising a light emitting diode; and
a sign panel, the sign panel being at least partially transparent, the light source being at least partially embedded in the sign panel, thereby illuminating the sign panel.

2. The illuminated sign defined by claim 1, wherein the sign panel comprises at least one of text, a symbol, a pictogram, and graphics at least one of engraved and disposed thereon.

3. The illuminated sign defined by claim 1, wherein the sign panel comprises at least one of text, a symbol, a pictogram, and graphics embedded therein.

4. The illuminated sign defined by claim 1, wherein the illuminated sign is adapted to be mounted to at least one of a wall and a ceiling.

5. The illuminated sign defined by claim 1, wherein the illuminated sign is adapted for use as an emergency exit sign.

6. The illuminated sign defined by claim 1, wherein the sign panel comprises two panels separated by reflective material.

7. The illuminated sign defined by claim 1, further comprising a holding fixture, the light source being at least partially disposed within the holding fixture, the holding fixture adapted to mount the sign panel to a mounting surface.

8. The illuminated sign defined by claim 7, wherein the holding fixture is adapted to position the sign panel at least one of parallel to the mounting surface and normal to the mounting surface.

9. The illuminated sign defined by claim 1, further comprising a positionable joint operatively coupled to the sign panel, the positionable joint being adapted to selectively orient the sign panel with respect to a mounting surface.

10. The illuminated sign defined by claim 1, wherein the light source comprises a high-intensity light emitting diode adapted to provide floodlighting.

11. A method of illuminating a sign comprising:
providing a light source comprising a light emitting diode; and
embedding the light source at least partially in a sign panel, the sign panel being at least partially transparent, thereby illuminating the sign panel.

12. The method of illuminating a sign defined by claim 11, further comprising at least one of disposing and engraving at least one of text, a symbol, a pictogram, and graphics on the sign panel.

13. The method of illuminating a sign defined by claim 11, further comprising embedding at least one of text, a symbol, a pictogram, and graphics in the sign panel.

14. The method of illuminating a sign defined by claim 11, further comprising mounting the sign panel to at least one of a wall and a ceiling.

15. The method of illuminating a sign defined by claim 11, wherein the sign panel comprises “EXIT” thereon.

16. The method of illuminating a sign defined by claim 11, further comprising providing the sign panel as two panels separated by reflective material.

17. The method of illuminating a sign defined by claim 11, further comprising disposing the light source at least partially within a holding fixture, the holding fixture adapted to mount the sign panel to a mounting surface.

18. The method of illuminating a sign defined by claim 11, further comprising positioning the sign panel at least one of parallel to a mounting surface and normal to a mounting surface.

19. The method of illuminating a sign defined by claim 11, further comprising coupling a positionable joint operatively to the sign panel, the positionable joint being adapted to selectively orient the sign panel with respect to a mounting surface.

20. The method of illuminating a sign defined by claim 11, wherein the light source comprises a high-intensity light emitting diode adapted to provide floodlighting.
